(19) United States
(12) Patent Application Publication
(10) Pub. No.: US 2010/0261448 A1
(43) Pub. Date: Oct. 14, 2010

(54) SYSTEM AND METHOD FOR EMERGENCY TEXT MESSAGING

(75) Inventor: Richard A. Peters, Grapevine, TX (US)

Correspondence Address: FULBRIGHT & JAWORSKI L.L.P, 2200 ROSS AVENUE, SUITE 2800, DALLAS, TX, 75201-2784, US

(73) Assignee: VIXXI Solutions, Inc., Greenwood Village, CO (US)

(21) Appl. No.: 12/421,490

(22) Filed: Apr. 9, 2009

(51) Int. Cl. H04M 11/04; H04W 4/00

(52) U.S. Cl. 455/404.1; 455/466

(57) ABSTRACT

Systems and methods for handling text messages directed to special numbers, such as emergency text messaging, are disclosed. In one embodiment, a method for routing a geographically-sensitive text message comprises receiving, at an intermediate router (between the sender and service point), a geographically-sensitive text message from a sending device that was sent to a universally known calling number. A present physical location of the sending device is determined based upon a knowledge of physical coordinates of the sending device, and based at least in part on the sending device's physical location, a proper service point (e.g., PSAP) to which the text message is to be routed is determined. The text message may be reformatted into a text output format of a text output display employed at the service point. The router sends the reformatted text message to the identified proper service point for display on the text output display.

### CROSS-REFERENCE TO RELATED APPLICATIONS

The present application is related to co-pending and commonly-assigned U.S. patent application Ser. No. 11/969,147 titled “GEOGRAPHIC REFERENCED TELEPHONE SWITCHING,” filed Jan. 3, 2008, which claims priority to U.S. Provisional Patent Application Ser. No. 60/980,697 titled “GEOGRAPHIC REFERENCED TELEPHONE SWITCHING,” filed Oct. 17, 2007, the disclosures of which are hereby incorporated herein by reference.

### TECHNICAL FIELD

The following description relates generally to text messaging, such as Short Message Service (SMS), Multimedia Messaging Service (MMS), or other forms of text messages that are directed to a special telephony number, such as a short code or long telephone number, for geographically-sensitive call handling, such as for emergency call handling, as with “9-1-1” emergency calls. The description further relates generally to a geographic-referenced telephone switching system and method for routing text messages to a proper endpoint (e.g., a proper public safety answering point or “PSAP”). The description further relates generally to systems and methods for communicating text messages to a proper endpoint in a format supported by the endpoint, such as in a proper format for being output to a PSAP's Automatic Location Information (“ALI”) display.

### BACKGROUND

Various systems have been proposed for handling telephone calls that are directed to a special number, such as emergency calls directed to telephone number 9-1-1. The basic 9-1-1 emergency call system is well-established in the United States, and other countries have similar systems for handling emergency calls. Such 9-1-1 calls are typically geographically-sensitive calls because the geographic location of the caller is generally important in determining the most appropriate emergency responder. For instance, the most appropriate fire, police, medical, or other emergency responder for a given caller may be determined based, at least in part, on the geographic location of the given caller. Various telecommunication systems have been proposed for handling geographically-sensitive calls, such as 9-1-1 calls.

Historical development and various operational aspects of the traditional 9-1-1 system in the U.S. are described in U.S. Pat. No. 4,893,325 titled “Integrated Public Safety Answering Point System”; U.S. Pat. No. 5,311,569 titled “Line-Based Public Safety Answering Point”; U.S. Pat. No. 6,385,302 titled “System and Method for Handling Special Number Calls Using On-Demand Answering Stations”; U.S. Pat. No. 6,587,545 titled “System for Providing Expanded Emergency Service Communication in a Telecommunication Network”; U.S. Pat. No. 6,744,859 titled “System and Apparatus for Providing Telephone Communication Between a Caller and a Special Number Call Answering Facility”; and U.S. Pat. No. 6,819,929 titled “System and Method for Routing Special Number Calls in a Telecommunication Network”, the disclosures of which are hereby incorporated herein by reference.

A basic 9-1-1 system provides for programming a telephone company end office (also known as a “central office” or a “Class 5 office”) with special 9-1-1 software for routing all 9-1-1 calls to a single destination. The single destination is generally referred to as a Public Safety Answering Point (PSAP). In such an arrangement, all telephones served by the central office have their 9-1-1 calls completed to the PSAP. However, the areas served by respective telephone company central offices do not line up with the political jurisdictions that determine the boundaries for which PSAP may be responsible. That is, a municipal fire department or police department may geographically include an area outside the area served by the central office, a condition known as underlap. Likewise, the municipal fire or police department may encompass an area of responsibility that is less expansive than the area served by the central office, a situation known as overlap. Further, the original basic 9-1-1 systems did not provide any automated identification of the caller; but instead relied upon the PSAP human operator to obtain such information verbally from the caller.

Automatic Number Identification (ANI) is a feature (sometimes referred to as Calling Party Number (CPN)) that allows the caller's telephone number to be delivered with the call. Such ANI information can accompany a call, such as a 9-1-1 call, and the ANI information may be displayed to an operator at the PSAP. The feature is useful for identifying the caller and, if the caller cannot communicate or if the call is dropped or disconnected for some reason, for callback. A signaling scheme known as Centralized Automatic Message Accounting (CAMA), originally used to identify the originator of a long distance call for billing purposes, was adapted to facilitate ANI delivery to the PSAP.

The availability of the caller's telephone number to the PSAP (the ANI feature) led quickly to providing the caller's name and address as well. This was straightforwardly accomplished using the subscriber information stored by telephone companies based upon telephone number since the 1980's. New equipment at the PSAP enabled queries of an Automatic Location Identification (ALI) database using the caller's number provided by the ANI feature to ascertain name and address information. The ALI databases are typically maintained by the respective telephone company serving the PSAP. This was an improvement, but a problem still remained where several telephone company central offices served a town or county.

Other problems also developed with the growing volume of mobile callers using wireless phones (e.g., cellular telephone, personal data assistant (PDA) devices, etc.), satellite phones and communications over the Internet. Information regarding the locus of the origin of the call merely identified the locus where the call entered the wireline network; even such limited location information is not always provided. No indication was presented to identify the geographic location of such mobile callers.

At the PSAP, operators generally have a telephone for receiving voice communication from a caller and an associated display (commonly referred to as an ALI display), such as a monitor, CRT, workstation, etc. for displaying textual information associated with a received call, such as the call's respective ANI and ALI information. The textual output displayed on the PSAP operator display may be in any of various predefined formats. For instance, the output to the display may be formatted into various predefined fields that are arranged on the screen in a predefined relative arrangement. As an example of typical operation, upon a call being received by the PSAP, the ANI information accompanying the call may be used to look up the caller's ALI information in the ALI database. When the voice portion of the call is connected to an operator at the PSAP, the associated ANI and/or ALI information may be displayed to the operator on the operator's display. The information associated with the call (e.g., ANI and/or ALI information) is used to paint (or “populate”) the operator's display screen. The associated information is fixed-field type data, having a fixed length, etc. And, if the wrong information is included in the wrong field, it shows up in the wrong place on the operator's display, or it does not show up at all. ALI databases and PSAP operator displays for displaying textual ANI and/or ALI information (e.g., ALI displays) are well-known in the art, and examples of such are discussed further in U.S. Pat. No. 6,104,784 titled “Arrangement for Communicating Between Public Safety Answering Points and an Automatic Location Identifier Database”; U.S. Pat. No. 6,363,138 titled “E-911/ALI Information Manager and Management System”; U.S. Pat. No. 6,526,125 titled “System and Method for Automatic Location Identification Discrepancy Notification”; and U.S. Pat. No. 7,177,400 titled “System and Method for Providing a Map Image Supplemental to Automatic Location Identification Information”, the disclosures of which are hereby incorporated herein by reference.

Currently, approximately 99% of the PSAPs in the United States are, from a telephony standpoint, analog based, which means that they receive information, both digital and voice information, using analog interfaces such as modems and analog trunking, such as CAMA trunks and/or Feature Group D or DSO-type trunking to the PSAP. In practice, there are currently no digital interfaces in PSAPs for receiving information, such as SMS messages, emails or any other form of digital (e.g., Internet Protocol (IP)) information. Each and every one of these PSAPs is connected to a database that contains location information (e.g., the ALI database). The format of this database generally determines how the PSAP operator's display screen is painted when location information is presented for an incoming call received by the PSAP. There are currently approximately 400 different information display formats in the U.S. 9-1-1 system.

As the situation of multiple central offices serving a PSAP occurred more frequently, it was clear that it was inefficient to build communication trunks from several central offices to a PSAP. As a result, the 9-1-1 Tandem was developed. With that equipment, trunks from central offices are concentrated at a tandem office (a 9-1-1 Tandem) from which a single trunk group serves a given PSAP. Often a 9-1-1 tandem comprises an otherwise common Class 5 telephone system end office (EO), with added software to configure it for 9-1-1 operations. Such concentration of trunks reduces size and cost of PSAP equipment. The tandem is a telephone company switch that provides an intermediate concentration and switching point. Tandems are used for many purposes, including intra-LATA (Local Access and Transport Area) toll calls, access to other local exchange carriers (LECs), and access to long distance carriers and telephone operators.

A significant development in 9-1-1 services has been the introduction of Enhanced 9-1-1 (E9-1-1). Some of the features of E9-1-1 include Selective Routing, ANI, ALI, Selective Transfer and Fixed Transfer. Selective Transfer enables one-button transfer capability to police, fire and EMS (Emergency Medical Service) agencies appropriate for the caller's location listed on the ALI display. Fixed Transfer is analogous to speed dialing.

Selective Routing is a process by which 9-1-1 calls are delivered to a specific PSAP based upon the street address of the caller. Selective Routing Tandems do not directly use address information from the ALI database to execute decisions regarding which PSAP to connect. Emergency services (e.g., police, fire and EMS) are typically delivered on a municipality basis. Often there will be one police department (e.g., municipal, county or state), but there may be several fire departments and EMS agencies. A town may be divided into response areas served by each respective agency. The response areas are overlaid and may be defined as geographic zones served by one particular combination of police, fire and EMS agencies. Such zones are commonly referred to as Emergency Service Zones (ESZ). Each ESZ contains the street addresses served by each type of responder. The ESZs are each assigned an identification number (usually 3-5 digits), known as Emergency Service numbers (ESN).

The Assignment of ESZs and corresponding ESNs enables the compilation of selective routing tables. The street addresses are derived from a Master Street Address Guide (MSAG), a database of street names and house number ranges within associated communities defining Emergency Service Zones (ESZs) and their associated Emergency Service Numbers (ESNs). This MSAG aids in proper routing of 9-1-1 calls by the 9-1-1 tandem; this is Selective Routing as implemented in an E9-1-1 system. Thus, the telephone company must have an MSAG valid address to be assigned the appropriate ESN for selective routing purposes and that information must be added to the 9-1-1 ALI database. It is by using such information that the selective routing capability of the Selective Routing Tandem can properly route a 9-1-1 call to the correct PSAP. If the information is not available in the ALI database, the record may be placed into an error file for further manual handling.

The advent of wireless communications has further exacerbated the difficulty of ascertaining caller location in telecommunication systems. The “patchwork” solutions described above regarding 9-1-1 systems have been mirrored in other special, or abbreviated number systems to a significant extent. The “patchwork” solutions have created a capability-limited telecommunication system that cannot ascertain geographic information as fully or as easily as it should for all types of callers. This capability limitation has been especially felt in connection with wireless telephone systems. The system is overly dependent upon human intervention to properly route calls to appropriate receivers, such as a proper PSAP. Newer modes of communication, such as Voice Over IP (Internet Protocol), further contribute to telecommunication traffic not identifiable regarding geographic origin using present telecommunication routing systems.

The above-described selective router system of E9-1-1 worked fairly efficiently until telephone end users were allowed to transport their telephone numbers outside of the geographic area of their central office servings boundaries either through Voice-Over-IP (VOIP) or through local number portability or through cellular services,.as examples. Once the actual telephone number could not be tied to a direct trunk group that was tied to a service responder, there were a tremendous amount of areas that show up in the database all the way from phone calls not being completed at all, to dispatching responders great distances when they didn't have to be dispatched. Therefore, the local number portability, the nomadic user of VOIP, and the ability to use cellular phones anywhere in the nation creates a crisis in switching systems for the telephone companies and for the 9-1-1 responders.

In 1998, the Federal Communications Commission (FCC) passed what it referred to as Wireless Phase I and Phase II. Wireless Phase I and Phase II were requirements for cellular providers to switch the 9-1-1 calls to PSAPs. In Phase I, the wireless provider was only required to switch the call to the PSAP that was closest to the antenna that picked up the cellular call. Almost all of the cellular companies now can switch Phase I calls with a very low error rate of around 20%. In Phase II, the cellular provider was required to give an XY coordinate destination of the telephone call within 150 feet. Once Global Positioning System (GPS) handsets become online or when some other triangulation technology such as AOA or GDOA become more refined, this Phase II requirement should be met more consistently within the industry.

Consequently, typically cellular companies currently merely switch 9-1-1 calls to the appropriate PSAP for the cellular towers that picked up the call. Recall that Phase I calls for switching to a PSAP that is closest to the antenna that picked up the cellular call, and now the cellular companies are trying to address more accurately switching to the appropriate PSAP. According to the National Emergency Number Association, while Phase II is implemented in about 20% of the NFL cities at this point and time, there are no providers that can switch to the appropriate PSAP without having some intermediary answer the call and transfer the call to the right PSAP.

As communications continue to evolve, challenges concerning handling of special, geographically-sensitive calls, such as emergency (e.g., 9-1-1 calls) continue to arise. As one example, VOIP is becoming a more common telecommunication platform. The FCC announced a Notice of Proposed Rulemaking that went into effect on Jan. 1, 2006. The announced rules required VOIP providers to access the current PSAP over the telephone switch network if the VOIP providers “touch” the public-switched network. VOIP providers who do not touch the public-switched network are not required to provide this access. So, with the problems that face the industry as far as selective routing and connecting calls were concerned, it would seem appropriate for a new and better type of switching environment to be developed.

As another example, callers are increasingly choosing to communicate via text messaging, rather than traditional voice calls. Users of mobile communication devices (e.g., cellular telephones, PDAs, and/or other wireless communication devices) are commonly communicating via text messaging, such as via Short Message Service (SMS), Multimedia Messaging Service (MMS), or other forms of text messages that are directed to a special telephony number, such as a short code or long telephone number.

The traditional 9-1-1 and E9-1-1 systems are not capable of handling text messages. An example of this shortcoming in the 9-1-1 and E9-1-1 systems was reflected in the Columbine School shootings in Colorado on Apr. 20, 1999, when students were hiding under their desks, afraid to speak, but texting messages to 9-1-1, and the text messages were not going through to a PSAP because there does not exist a national short code for such emergency calls. That is, while 9-1-1 is a universally recognized number for emergency voice telephone calls, 9-1-1 is not recognized as a universal short code for text messaging. Text messaging short codes are generally 5 or 7 characters in length, and 9-1-1 has not been established as an emergency short code for text messages. To date, no universally recognized emergency short code for text messages has been established in the U.S. (or within any state or other jurisdiction of the U.S.).

Consequently, the National Emergency Number Association (NENA) and the Association of Public Communications Officers (APCO) have presented several papers on the need to distribute text messages to the correct PSAP should a caller attempt to communicate via text messaging rather than a voice call. One problem with a text message is difficulty in determining a corresponding geographic origination point of the text message. Therefore, difficulty arises in determining the proper destination or emergency responder to be contacted for responding to the sender of the text message.

Conventional 9-1-1 and E9-1-1 systems have failed to provide a method for handling emergency text messages, but instead rely fully on voice connections for receiving emergency calls. In addition, wireless telephony networks, such as conventional GSM-based networks, tail to provide a method for communicating emergency messages using non-voice connections. Traditionally, one must speak with and give location information to an emergency operator in order to summon help when using a cellular or wireless phone. Emergency operators at PSAPs traditionally monitor voice calls only, and monitoring of emergency calls of types other than speech, such as text messaging calls, are not available in current PSAP implementations. U.S. Pat. No. 6,397,054 titled “Features for Emergency Calling and Short Messaging System” discusses some of the issues concerning lack of support for emergency text messaging in traditional wireless telephony systems.

A series of suggestions have been laid out by NENA in order to expand the type of information that can be received and processed in a PSAP, which are commonly referred to as the next generation 9-1-1. The suggestions include several elements that allow for interchange of information in order to process calls. The suggestions also leave room for the ability to add data into the existing structure that is not necessarily ALI or Emergency Record Database (ERDB) information, such as text information.

So, the industry has called for people to find a way to deliver such information as text messaging for handling by PSAPs. To date, this call has gone unanswered in the industry.

### SUMMARY

In view of the above, various shortcomings in the current 9-1-1 and E9-1-1 systems have prevented them from handling emergency text messages. First, no universal short code has been established for emergency text messaging in the United States or any of its jurisdictions (e.g., states). One reason that no such universal short code has been established is because no system has existed for taking the text messages directed to such a universal short code and forwarding them to the proper destination (e.g., to the proper PSAP). Also, the current 9-1-1 and E9-1-1 systems have failed to address the geographic sensitivity of text messages. For instance, traditional telephone routing devices are ANI based. In many texting devices, such as cellular telephones, PDAs, or other mobile communication devices, a particular ANI can be at any particular place at any particular point in time. So, difficulty arises in determining a current geographical location of a caller who is sending a text message, and difficulty arises in routing the text message to an appropriate endpoint (e.g., to a proper PSAP) based on such geographical location. Further, traditional PSAPs are not equipped to receive text messages. Traditional PSAPs are equipped to receive voice calls and standard ANI and ALI messages. Thus, capability of receiving non-voice communication, such as a text message, and properly displaying such text message to a PSAP operator (e.g., on the PSAP's existing display equipment) has not been supported by PSAPs.

The present invention is directed generally to systems and methods for handling text messages directed to special numbers, such as emergency text messaging. According to certain embodiments of the present invention, a sending communication device may send a text message to a predefined universal special number. For instance, a universal short code of “US911” may be established and recognized as a special number for emergency text messaging in the U.S. As another example, “CA911” may be established and recognized as a special number for emergency text messaging in the state of California. Thus, a universal special number may be established and recognized for emergency text messages in any given jurisdiction, such as throughout the U.S. (or some foreign territory) or within a given state or other locality.

As used herein, text messaging refers to any form of text messages that are directed from a sending device to a destination telephone number (which, as discussed further herein, may be a special telephone number, such as a short code or long telephone number for emergency calls). Examples of such text messages include, without limitation, Short Message Service (SMS), Multimedia Messaging Service (MMS), and a text file (e.g., a “.txt” file) directed to a destination telephone number.

According to certain embodiments, a text message may be manually entered into the sending device by a user and directed to the predefined universal special number using conventional text messaging techniques. In certain embodiments, a text messaging application executing on the sending device or on a server device with which the sending device is in communication may aid the user in generating and sending a text message. For instance, a text messaging application may provide various predefined text messages from which a user may select to send. This may expedite the user's generation of a text message, and/or may aid a user in completing certain information to be included in a text message of a certain type. As one example, a user may select a predefined text message of “I am having a heart attack” to send. As another example, a user may select a certain type of message, such as a Medical Emergency type of message, and responsive to such selection the text messaging application may prompt the user for certain information, such as the type of medical emergency, the name of the user's physician, etc. that is to be included in the text message. In certain implementations, responsive to a user selecting a certain type of message to send (e.g., Medical Emergency type), the text messaging application may present the user (on the sending device interface) a form or template text message that includes various fields, such as type of medical emergency, name of user's physician, etc., that may be completed by the user. This may aid the user in providing necessary/important information concerning the type of emergency being experienced. In certain embodiments, various user-defined text messages, which may be pre-populated by the user with various information, such as the user's medical condition, physician name and contact information, etc. may be stored for selection by the user to send. Thus, for example, a user with a known heart condition may have a pre-stored text message that can be quickly selected and sent upon the user experiencing symptoms of a heart attack, rather than the user being required to type out a text message while experiencing those symptoms.

In certain embodiments, the sending device may autonomously generate the text message based, for instance, on detection of certain environmental or other conditions. As one example, the sending device may be part of or in communication with a medical monitoring device which may be monitoring a user's health, such as monitoring the user's heart rate, blood pressure, etc., and responsive to the medical monitoring device detecting, based on its monitored health information about the user, that an emergency condition exists for the user (e.g., the user is experiencing a heart attack), the sending device may autonomously generate a text message (or autonomously select a pre-generated text message that is stored for retrieval) that includes information identifying the medical emergency and send the text message to the predefined universal special number. As another example, the sending device may be part of or in communication with a motor vehicle, and upon detection of a physical impact experienced by the motor vehicle (i.e., the motor vehicle is in a wreck), the sending device may autonomously generate a text message (or autonomously select a pre-generated text message that is stored for retrieval) that includes information identifying that a motor vehicle wreck has been detected and send the text message to the predefined universal special number. Thus, in certain embodiments, a text message may be autonomously generated and/or sent to the predefined universal special number with no or minimal involvement of the user. Such feature may be particularly useful in instances in which the user is unaware of the emergency condition (e.g., does not recognize symptoms of a medical emergency condition) and/or is unable to perform manual tasks necessary for generating and sending a text message.

In certain embodiments, a user may manually select to attach certain information to be included in or to be sent accompanying the text message. As an example, the sending device may have an integrated digital photograph camera, video camera, audio recording device, and/or other mechanism for capturing information about the user's surroundings, wherein the user may capture such information (e.g., photographs, etc.) and include the information with the text message being sent (e.g., as an accompanying attachment). In certain embodiments, the text messaging application may be configured to autonomously include in or attach to a text message that is being sent to the predefined universal special number (e.g., to a designated emergency text message short code, such as US911) certain information, such as a user's pre-defined personal profile, which may include various information about the user like the user's emergency contacts, physician information, medical condition information, allergy information, etc.

In according with certain embodiments of the present invention, the predefined special number may terminate in a certain intermediate router that is implemented for handling the text messaging as described further herein. Such a router is referred to herein as an “intermediate router” because it is logically disposed in the communication path between the sender of the text message and the endpoint (e.g., PSAP) that is to receive and service the text message. Such intermediate router may be implemented as any processor-based device that is configured to perform operations as described herein. The intermediate router may be a switch or router within a telephony network (e.g., that also performs other switching and/or routing tasks in addition to those described herein), or it may be dedicated device implemented within the network for handling text messaging as discussed herein. Further, the intermediate router may comprise a plurality of processor-based devices, which may be implemented in a distributed manner (e.g., distributed throughout the telephone network) for performing the operations described herein. Thus, in certain embodiments all text messages that are directed to the designated special number (e.g., US911) may be routed to the intermediate router, as described further herein, for processing and routing to a proper endpoint, such as to a proper PSAP.

In one embodiment, in addition to receiving a text message, the intermediate router determines the current geographical location of the sending device from which the text message originated. In certain embodiments, the intermediate router may receive geographic coordinates of the sending device from position determining equipment (PDE), mobile positioning center (MPC), or other device in the wireless telephony network that is aware of such geographic coordinates of the sending device. Such geographic coordinates may be pushed automatically to the intermediate router for the text message, or the intermediate router may request the geographic coordinates from the PDE or other device. In certain embodiments, the intermediate router may receive the geographic location information from the sending device itself. For instance, the sending device may include a GPS system or other position-determining equipment, and the sending device itself may send, along with the text message, its respective geographic coordinate information to the intermediate router.

In one embodiment, the intermediate router determines the proper endpoint (e.g., the proper PSAP) to which the text message is to be sent for servicing. Such proper endpoint may be determined based, at least in part, on the determined current geographical location of the sending device. For instance, in certain embodiments, this determination is performed as a database lookup using the determined geographical location of the sending device for determining from the database a corresponding endpoint (e.g., PSAP) for servicing the text message. Exemplary techniques for performing geospatial routing, which may be adapted for use by the intermediate router as described further herein, are described in co-pending and commonly-assigned U.S. patent application Ser. No. 11/969,147 titled “GEOGRAPHIC REFERENCED TELEPHONE SWITCHING,” filed Jan. 3, 2008, which claims priority to U.S. Provisional Patent Application Ser. No. 60/980,697 titled “GEOGRAPHIC REFERENCED TELEPHONE SWITCHING,” filed Oct. 17, 2007, the disclosures of which are incorporated herein by reference.

In certain embodiments, the intermediate router may further determine a format of a text output display at the endpoint, such as the format that is supported at a PSAP ALI display for displaying textual information. As discussed above, the textual output displayed on the PSAP operator display (e.g., ALI display) may be in any of various predefined formats. For instance, the output to the display may be formatted into various predefined fields that are arranged on the screen in a predefined relative arrangement. Generally, the textual information accompanying a voice emergency call (e.g., ANI and/or ALI information) is fixed-field type data, having a fixed length, etc. for output on the PSAP operator display. The specific textual format supported by the PSAP's output display to which the text message is to be routed may be determined via a database lookup by the intermediate router. For instance, a database to which the intermediate router may be communicatively coupled may contain information specifying, for each PSAP, a corresponding text output format that is supported by the PSAP's operator displays (e.g., such as the displays that are employed at the PSAP for presenting ANI and/or ALI information associated with a voice emergency call).

According to certain embodiments, the intermediate router may, when needed, re-format the received text message into a different format to be compatible with the text output display at the endpoint. For instance, once the intermediate router determines the text output format that is supported by the operator displays of the particular PSAP to which the text message is to be routed, the intermediate router may reformat the received text message to be compatible with the determined text output format. In this way, the reformatted text message may be sent to the PSAP for display on the operator display that is traditionally used for displaying textual information associated with a voice emergency call (e.g., ANI and/or ALI information). Accordingly, the PSAP's existing operator displays that are employed for displaying ANI and/or ALI information associated with traditional voice emergency calls may likewise be employed for displaying the emergency text messages, as reformatted by the intermediate router. As an example, in one embodiment, a received text message (e.g., SMS message) can be reformatted to match the screen display format (or “painting”) on any particular PSAP, and the intermediate router may then transmit the reformatted text message as if it were in an ALI database so that the PSAP can receive it and display it as it traditionally would display ALI information accompanying a voice emergency call. In this way, the PSAP is not required to upgrade or modify its traditional equipment that is employed for handling voice emergency calls, but can choose to instead use its existing, traditional equipment for receiving emergency text messages, thereby readily expanding its capability for serving the public's emergency communication desires.

In certain embodiments, the intermediate router then sends the text message (e.g., the re-formatted text message) to the determined endpoint (e.g., the determined PSAP) for servicing.

According to certain embodiments of the present invention, the intermediate router is configured to autonomously perform the above-described tasks associated with receiving a text message, processing the text message (e.g., determining a proper endpoint, determining a text output display format supported at the endpoint, reformatting the text message, and sending the text message (e.g., as reformatted) to the determined proper endpoint). Thus, no human intervention is required, in certain embodiments, at the intermediate router for handling a given text message.

The intermediate router may, in certain embodiments, further send a corresponding voice announcement to the endpoint (e.g., PSAP) to notify the operator at the endpoint that the text message has been received and that there is no voice communication for the call. Thus, upon sending an emergency text message to a PSAP, the intermediate router may initiate a corresponding voice call to the PSAP to play a recorded announcement informing the PSAP operator of the incoming emergency text message. In certain embodiments, the intermediate router may, in addition to or instead of sending the text message to the PSAP, perform a text-to-speech conversion of the text message, and communicate the resulting speech to the PSAP operator via the voice call, along with an announcement to the operator that the speech originated from a text message.

In certain embodiments, the intermediate router may attach to or edit the text message to include personal information relating to the sender. For instance, a personal profile may be created and stored in a database that is communicatively accessible by the intermediate router, which may include such information as personal contacts (e.g., information about persons to be contacted in the event of an emergency), medical conditions, allergy information, etc. As another example, in certain embodiments, the intermediate router may perform a language translation or other editing of the text message.

In accordance with certain embodiments, a PSAP that handles traditional voice emergency calls (e.g., traditional 9-1-1 and/or E9-1-1 calls) may readily further handle emergency text messages without requiring equipment modifications or upgrades within the PSAP. For instance, the intermediate router may reformat a text message to be compatible with the existing text output display employed at a PSAP such that an emergency text message may be displayed on the same text output display that information associated with a voice call (e.g., ANI and/or ALI information) is displayed. Thus, embodiments of the present invention enable PSAPs to readily handle emergency text messages using the traditional equipment that they have employed for handling traditional voice emergency calls. Of course, embodiments of the present invention may likewise be employed for PSAPs that have upgraded capabilities for receiving text messages. For instance, the intermediate router may discover (e.g., from its database lookup) that a PSAP has equipment for receiving text messages, and thus reformatting of the received text message before routing it to the PSAP may be unnecessary for certain PSAPs.

While emergency (e.g., 9-1-1 or E9-1-1 type calls) are described in many of the exemplary embodiments provided herein, it should be recognized that the concepts described herein may be likewise employed for other special calling systems. For example, there are other abbreviated number calling systems in place in the United States and abroad for such purposes as handling municipal information and services calls (e.g., 3-1-1 calls) and for other special purposes. All of these special, or abbreviated number call systems that have geographic-based content may be implemented for supporting text messaging to an action-response facility geographically proximate to the locus of the caller in a manner similar to that described herein for emergency text messaging.

U.S. Pat. No. 6,397,054 (hereafter “the '054 patent”) titled “Features for Emergency Calling and Short Messaging System” discusses some of the issues concerning lack of support for emergency text messaging in traditional wireless telephony systems. The '054 patent proposes adding two new parameters to conventional GSM-based emergency calling procedure, namely a new cause (Emergency SDCCH Procedure cause) in order to indicate to the network that the mobile station wishes to establish an emergency procedure that completes on the SDCCH, and a new service type is added to the service request message (i.e., CM SERVICE REQUEST) in order to identify that the service requested by the mobile station is an emergency short message service, see col. 5, lines 8-30 of the '054 patent. Municipalities may then monitor messages transmitted using this service, see col. 5, lines 54-61 of the '054 patent. This solution, alone, proposed by the '054 patent would require changes at the PSAP to implement new equipment for receiving and responding to the text messages. Embodiments of the present invention may be employed with the solution proposed in the '054 patent, as an example. For instance, the additional parameters suggested by the '054 patent may be employed to route a text message to an intermediate router as discussed further herein, wherein the intermediate router may process the text to determine the proper PSAP, reformat the text message to be compatible with the PSAP operator ALI display, and send the reformatted text message to the PSAP, as one example.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an exemplary system according to one embodiment of the present invention;

FIG. 2 shows an exemplary block diagram of one embodiment of the text message router of FIG. 1;

FIG. 3 shows an exemplary user interface that a text messaging application may present to a user of a text message sending device;

FIG. 4 shows an exemplary PSAP operator station that may be implemented within a PSAP to which a text message may be routed from the exemplary text message router of FIG. 1; and

FIG. 5 shows an operational flow diagram of an intermediate router (e.g., the text message router of FIG. 1) according to one embodiment of the present invention.

### DETAILED DESCRIPTION

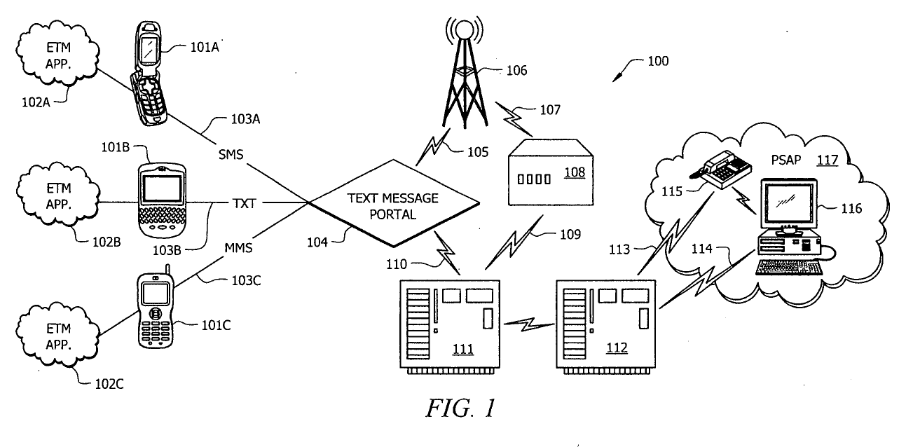

FIG. 1 shows an exemplary system 100 according to one embodiment of the present invention. Exemplary system 100 comprises a plurality of communication devices that are operable to send text messages, such as cellular telephone 101A, PDA (e.g., Blackberry® or other brand of wireless handheld device, etc.) 101B, and WiFi device 101C (e.g., an IP version 6 device that will provide the router and the DNS for that particular device from which the device location may be determined based on a universal dictionary of router location). Communication devices 101A-101C may be referred to herein as “sending devices” because they send text messages, as discussed further herein. Of course, the devices may include further operability for receiving text messages, as well as performing other types of communication, such as enabling voice telephone calls, etc. Various types of devices that provide text messaging (and, in some instances, other types of communication) are well-known in the art.

While three exemplary devices 101A-101C are shown in FIG. 1, it will be understood that any number of devices may be implemented, and three are merely shown for ease of illustration. Further, while exemplary devices 101A-101C are shown and described in connection with FIG. 1, it will be understood that these types of communication devices are merely illustrative, and any type of processor-based communication device that is operable for sending text messages may be likewise employed within the scope of the present description. As one example, such communication devices (e.g., devices 101A-101C) may comprise mobile stations (e.g., handheld devices, etc.) that are operable to communicate text messages and/or other forms of communication wirelessly (e.g., via a wireless telephone network, such as Global System for Mobile Communications (GSM)-based cellular network, code division multiple access (CDMA)-based cellular network, satellite communication system, and/or other wireless communication network) according to techniques well known in the art of wireless communication.

As used herein, text messaging refers to any form of text messages that are directed from a sending device (such as devices 101A-101C) to a destination telephone number (which, as discussed further herein, may be a special telephone number, such as a short code or long telephone number for emergency calls). Examples of such text messages include, without limitation, Short Message Service (SMS), Multimedia Messaging Service (MMS), and a text file (e.g., a “.txt” file) directed to a destination telephone number.

Each of devices 101A-101C may include a text messaging software application, such as an emergency text messaging (ETM) application 102A-102C, executing on the device (or executing on a server computer to which the device is communicatively coupled) to enable creation and sending of a text message to a destination telephone number. As an example, communication device 101A may enable a user to create (e.g., via its ETM application 102A) a SMS text message 103A, which the communication device 101A may send (e.g., via its text message communication interface) to a destination telephone number. Similarly, communication device 101B may enable a user to create (e.g., via its ETM application 102B) a .txt text message 103B, which the communication device 101B may send (e.g., via its text message communication interface) to a destination telephone number. As another example, communication device 101C may enable a user to create (e.g., via its ETM application 102C) a MMS text message 103C, which the communication device 101C may send (e.g., via its text message communication interface) to a destination telephone number.

According to certain embodiments of the present invention, a sending communication device 101A-101C may send a text message to a predefined universal special number. For instance, a universal short code of “US911” may be established and recognized as a special number for emergency text messaging in the U.S. As another example, “CA911” may be established and recognized as a special number for emergency text messaging in the state of California. Thus, a universal special number may be established and recognized for emergency text messages in any given jurisdiction, such as throughout the U.S. (or some foreign territory) or within a given state or other locality.

In according with certain embodiments of the present invention, the predefined special number may terminate in a certain intermediate router that is implemented for handling the text messaging as described further herein. For instance, the predefined special number may terminate in a text message portal 104. Text message portal 104 may be any processor-based device (e.g., router, switch, etc.) in which the predefined special number terminates. Thus, in this exemplary embodiment, all text messages sent to the predefined special number are routed by the telecommunication network to the text message portal 104.

An “intermediate router” in this exemplary embodiment may be formed by one or more of the text message portal 104 and devices 111 and 112 described further herein. While text message portal 104 and devices 111 and 112 are illustrated as separate components in FIG. 1, it will be understood that all or a portion of these devices may be integrated into a single device. Further, while each of devices 104, 111, and 112 are shown as a single device in FIG. 1, it will be understood that one or more of such devices may comprise a plurality of devices (e.g., implemented in a distributed manner) for performing the corresponding functionality described for such device.

Such a router is referred to herein as an “intermediate router” because it is logically disposed in the communication path between the sender of the text message (at sending devices 101A-101C) and the endpoint (e.g., PSAP 117) that is to receive and service the text message. Such intermediate router may be implemented as any one or more processor-based devices configured to perform operations as described herein.

In the illustrated embodiment, the text message portal 104 sends the received text message, via communication 110 (which may be via a wireless telecommunication network, an IP network, or other suitable communication network) to location determining device 111. Location determining device 111 determines the current geographical location of the sending device from which the text message originated. In certain embodiments, the location determining device 111 may receive geographic coordinates of the sending device from position determining equipment (PDE), mobile positioning center (MPC), or other device in the wireless telephony network that is aware of such geographic coordinates of the sending device, such as device 108 shown in FIG. 1. In certain embodiments, such geographic coordinates may be pushed automatically to the location determining device 111. For instance, the text message may be routed via a base station 106 in a wireless telecommunication network, and upon the base station 106 recognizing that the text message is destined for the predefined special number (e.g., US911), the base station may trigger, via communication 107, the device (e.g., PDE or MPC) 108 to send corresponding current geographic coordinates associated with the sending device 101A-101C to location determining device 111. In certain embodiments, upon text message portal 104 receiving the text message (e.g., via communication 105) from base station 106, the text message portal 104 may request the base station 106 to trigger the device (e.g., PDE or MPC) 108 to send corresponding current geographic coordinates associated with the sending device 101A-101C to location determining device 111. In either case, the geographic coordinates associated with the sending device may be communicated via communication 109 (which may be via a wireless telecommunication network, an IP network, or other suitable communication network) from device 108 to location determining device 111.

In certain embodiments, the location determining device 111 may, instead of being pushed the geographic location information for a sending device, request the geographic coordinates from the device 108. Thus, for instance, responsive to location determining device 111 receiving the text message from text message portal 104, location determining device 111 may request the current geographic coordinates of the sending device from the device 108. Consistent with Phase I and Phase II of the FCC 1999 wireless ruling and legislation from Congress concerning the Enhanced 911 Act that was passed in October of 2008 (which allows for the first time VSPs (Voice System Providers) and VPCs (VOIP Positioning Centers) access to the cellular telephone company's X-Y coordinate information, the current geographic coordinates of the sending device may be obtained by location determining device 111.

Of course, while location determining device 111 determines the geographic location of the sending device by receiving the geographic coordinates that are maintained in the wireless telecommunication network (via device 108) in this exemplary embodiment, the geographic location of the sending device may be determined in any other suitable way in certain embodiments. For instance, in one embodiment, the location determining device 111 may may receive the geographic location information from the sending device 101A-101C itself. For instance, the sending device may include a GPS system or other position-determining equipment, and the sending device itself (e.g., 101A-101C) may send, along with the text message, its respective geographic coordinate information.

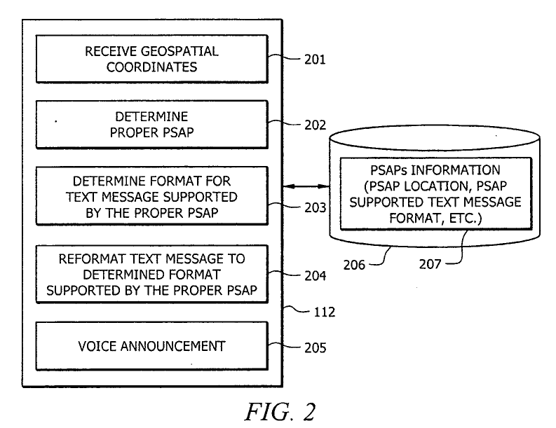

In the exemplary embodiment of FIG. 1, the text message and corresponding geographical location information of the sending device are sent from location determining device 111 to text message router 112. Text message router 112 determines the proper endpoint (e.g., the proper PSAP) to which the text message is to be sent for servicing. Such proper endpoint may be determined based, at least in part, on the determined current geographical location of the sending device. For instance, in certain embodiments, this determination is performed as a database lookup (e.g., as discussed further below with database 206 of FIG. 2) using the determined geographical location of the sending device for determining from the database a corresponding endpoint (e.g., PSAP) for servicing the text message. Exemplary techniques for performing geospatial routing, which may be adapted for use by the text message router as described further herein, are described in co-pending and commonly-assigned U.S. patent application Ser. No. 11/969,147 titled “GEOGRAPHIC REFERENCED TELEPHONE SWITCHING,” filed Jan. 3, 2008, which claims priority to U.S. Provisional Patent Application Ser. No. 60/980,697 titled “GEOGRAPHIC REFERENCED TELEPHONE SWITCHING,” filed Oct. 17, 2007, the disclosures of which are incorporated herein by reference.

Again, all or a portion of the text message portal 104, location determining device 111, and/or text message router 112 may be referred to herein as an “intermediate router”. And, while shown as individual devices for ease of illustration, two or more of the devices 104, 111, and 112 may be integrated into a single device in certain implementations. Further, these devices forming the “intermediate router” may be implemented in a distributed manner across a plurality of devices (e.g., that are distributed across a communication network) in certain embodiments.

In certain embodiments, the text message router 112 may further determine a format of a text output display at the endpoint, such as the format that is supported at a PSAP ALI display for displaying textual information. For instance, a PSAP 117 to which the text message is to be routed may include one or more textual output displays 116, which may be employed at the PSAP 117 for displaying ANI and/or ALI information associated with received voice emergency calls. The PSAP 117 may also include one or more voice telephones 115 that are commonly used by PSAP operators for receiving voice emergency calls. As discussed above, the textual output displayed on the PSAP operator display (e.g., ALI display) 116 may be in any of various predefined formats. For instance, the output to the display 116 may be formatted into various predefined fields that are arranged on the screen in a predefined relative arrangement. Generally, the textual information accompanying a voice emergency call (e.g., ANI and/or ALI information) is fixed-field type data, having a fixed length, etc. for output on the PSAP operator display 116.

In certain embodiments, the specific textual format supported by the PSAP's output display 116 to which the text message is to be routed may be determined via a database lookup by the text message router 112. For instance, a database to which the text message router 112 may be communicatively coupled may contain information specifying, for each PSAP, a corresponding text output format that is supported by the PSAP's operator displays 116 (e.g., such as the displays that are employed at the PSAP for presenting ANI and/or ALI information associated with a voice emergency call).

According to certain embodiments, the text message router 112 may, when needed, re-format the received text message into a different format to be compatible with the text output display 116 at the endpoint. For instance, once the text message router 112 determines the text output format that is supported by the operator displays 116 of the particular PSAP 117 to which the text message is to be routed, the text message router 112 may reformat the received text message to be compatible with the determined text output format. In this way, the reformatted text message may be sent to the PSAP 117 for display on the operator display 116 that is traditionally used for displaying textual information associated with a voice emergency call (e.g., ANI and/or ALI information). Accordingly, the PSAP's existing operator displays 116 that are employed for displaying ANI and/or ALI information associated with traditional voice emergency calls may likewise be employed for displaying the emergency text messages, as reformatted by the text message router 112, in accordance with certain embodiments.

As an example, in one embodiment, a received text message (e.g., SMS message) can be reformatted to match the screen display format (or “painting”) of any particular PSAP, and the text message router 112 may then transmit, via communication 114, the reformatted text message to the display 116 of PSAP 117 as if the text message were from an ALI database. In this way, the text message may be formatted so as to be compatible with the ALI database information received and displayed by display 116 for voice emergency calls. So, the PSAP 117 may, in accordance with certain embodiments, receive the text message and display it on display 116 as it traditionally would display ALI information accompanying a voice emergency call. Accordingly, the PSAP 117 is not required to upgrade or modify its traditional equipment that is employed for handling voice emergency calls, but can choose to instead use its existing, traditional equipment (e.g., display 116) for receiving emergency text messages, thereby readily expanding its capability for serving the public's emergency communication desires.

In certain embodiments, the text message router 112 may further send, via voice connection 113, a corresponding voice announcement to the PSAP 117 to notify the operator at the PSAP that the text message has been received and that there is no voice communication for the call. Thus, upon sending an emergency text message to PSAP 117, the text message router 117 may initiate a corresponding voice call to the PSAP 117 to play (on an operator's telephone 115) a recorded announcement informing the PSAP operator of the incoming emergency text message, which is displayed on the operator's display 116. In certain embodiments, the text message router 112 may, in addition to or instead of sending the text message to the PSAP 117, perform a text-to-speech conversion of the text message, and communicate the resulting speech to the PSAP operator via the voice call 113, along with an announcement to the operator that the speech originated from a text message.

In certain embodiments, the text message router 112 may attach to or edit the text message to include personal information relating to the sender. For instance, a personal profile may be created and stored in a database that is communicatively accessible by the text message router 112, which may include such information as personal contacts (e.g., information about persons to be contacted in the event of an emergency), medical conditions, allergy information, etc. Thus, this further information may be included in or attached to the text message that is sent from text message router 112 to the PSAP 117. As another example, in certain embodiments, the text message router 112 may perform a language translation or other editing of the text message prior to sending to the PSAP 117.

In accordance with certain embodiments, a PSAP 117 that handles traditional voice emergency calls (e.g., traditional 9-1-1 and/or E9-1-1 calls) may-readily further handle emergency text messages without requiring equipment modifications or upgrades within the PSAP. For instance, the text message router 112 may reformat a text message to be compatible with the existing text output display 116 employed at a PSAP 117 such that an emergency text message may be displayed on the same text output display 116 that information associated with a voice call (e.g., ANI and/or ALI information) is displayed. Thus, certain embodiments of the present invention enable PSAPs to readily handle emergency text messages using the traditional equipment that they have employed for handling traditional voice emergency calls. Of course, embodiments of the present invention may likewise be employed for PSAPs that have upgraded capabilities for receiving text messages. For instance, the text message router 112 may discover (e.g., from its database lookup) that a PSAP 117 has equipment for receiving text messages, and thus reformatting of the received text message before routing it to the PSAP may be unnecessary for certain PSAPs.

According to certain embodiments of the present invention, the intermediate router (e.g., text message portal 104, location determining device 111, and text message router 112) is configured to autonomously perform the above-described tasks associated with receiving a text message, processing the text message (e.g., determining a proper endpoint, determining a text output display format supported at the endpoint, reformatting the text message, and sending the text message (e.g., as reformatted) to the determined proper endpoint). Thus, no human intervention is required, in certain embodiments, at the intermediate router for handling a given text message.

Turning to FIG. 2, an exemplary block diagram of one embodiment of text message router 112 is shown. In this example, text message router 112 includes an interface 201 for receiving (e.g., from location determining device 111 or from device 108 or some other device, such as from the sending device 101A-101C itself) geospatial coordinates identifying the current physical location of the sending device.

Text message router 112 further includes logic 202 (e.g., software stored to a computer-readable medium and being executed by a processor of the text message router 112) to determine a proper endpoint (e.g., a proper PSAP) to which the text message is to be routed. For instance, text message router 112 may be communicatively coupled to a database 206 that is stored to a computer-readable medium (e.g., hard drive, memory, optical disc, magnetic disk, or other data storage device for storing computer-readable data), wherein database 206 includes PSAP information 207, such as information specifying a corresponding geographical area serviced by each PSAP, each PSAP's supported text display format, etc. Thus, the proper PSAP (or other endpoint) for handling a geographically-sensitive text message may be determined by logic 202 of text message router 112 via querying database 206.

Text message router 112 further includes logic 203 (e.g., software stored to a computer-readable medium and being executed by a processor of the text message router 112) to determine a text message format supported by the given PSAP (or other endpoint) to which the text message is to be routed (as determined by logic 202). For instance, the text output format of the PSAP operator display 116 (of FIG. 1) may be determined by logic 203. Again, such format may be determined by querying database 206 for this PSAP information 207.

Text message router 112 further includes logic 204 (e.g., software stored to a computer-readable medium and being executed by a processor of the text message router 112) to reformat the received text message into the determined format that is supported by the given PSAP (or other endpoint) to which the text message is to be routed (as determined by logic 202). Exemplary techniques that may be employed for performing such reformatting may include those as disclosed in concurrently-filed and commonly-assigned U.S. patent application Ser. No. ______ [Attorney Docket No. 73729/P001CP1 titled “System And Method For Flexible Forwarding Of Emergency Call Information”, the disclosure of which is hereby incorporated herein by reference.

In addition to a text message interface for receiving a text message from a sender and for sending a text message (e.g., a reformatted text message) to a determined endpoint (e.g., a determined PSAP 117), text message router 112 may further include a voice communication interface and announcement logic 205 (e.g., software stored to a computer-readable medium and being executed by a processor of the text message router 112) to play a corresponding voice announcement to notify an operator at the endpoint (e.g., PSAP) of the text message.

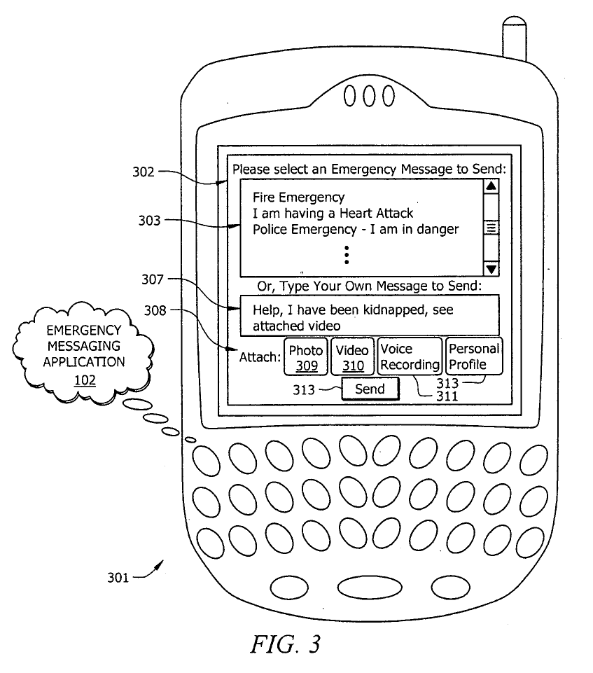

FIG. 3 shows an exemplary user interface 302 that a text messaging application 102 (e.g., an emergency text messaging or ETM application) may present to a user of a text message sending device 301 (which may be any of devices 101A-101C of FIG. 1, as examples). According to certain embodiments, a text message may be manually entered into the sending device 301 by a user and directed to the predefined universal special number using conventional text messaging techniques. For instance, a text message may be manually entered into a text input field 307. In the illustrated example of FIG. 3, the user has input the text message “Help, I have been kidnapped, see attached video” to text message input field 307.

In certain embodiments, text messaging application 102 executing on the sending device 301 or on a server device with which the sending device 301 is in communication may aid the user in generating and sending a text message. For instance, text messaging application 102 may provide various predefined text messages 303 from which a user may select to send. In the illustrated example, predefined messages for Fire Emergency 304, I am Having a Heart Attack 305, and Police Emergency—I am in danger 306 are available for user selection. This may expedite the user's generation of a text message, and/or may aid a user in completing certain information to be included in a text message of a certain type. As one example, a user may select a predefined text message of “I am having a heart attack” 305 to send. As another example, a user may select a certain type of message, such as “Medical Emergency”, and responsive to such selection the text messaging application 102 may prompt the user for certain information, such as the type of medical emergency, the name of the user's physician, etc. that is to be included in the text message. In certain implementations, responsive to a user selecting a certain type of message to send (e.g., Medical Emergency type), the text messaging application may present the user (on the sending device interface) a form or template text message that includes various fields, such as type of medical emergency, name of user's physician, etc., that may be completed by the user. This may aid the user in providing necessary/important information concerning the type of emergency being experienced. In certain embodiments, various user-defined text messages, which may be pre-populated by the user with various information, such as the user's medical condition, physician name and contact information, etc. may be stored for selection by the user to send. Thus, for example, a user with a known heart condition may have a pre-stored text message that can be quickly selected and sent upon the user experiencing symptoms of a heart attack, rather than the user being required to type out a text message while experiencing those symptoms.

In certain embodiments, a user may manually select to attach certain information to be included in or to be sent accompanying the text message. As an example, the sending device may have an integrated digital photograph camera, video camera, audio recording device, and/or other mechanism for capturing information about the user's surroundings, wherein the user may capture such information (e.g., photographs, etc.) and include the information with the text message being sent (e.g., as an accompanying attachment). Thus, interface 302 may include an attachment interface 308 that allows the user to select any one or more of buttons 309-312 to attach a photo, video, voice recording, or personal profile, respectively. For instance, responsive to selecting photo button 309, an interface may be presented to allow the user to select a photo that is stored to the sending device 301 to be attached to the text message being sent. This may allow the user to easily communicate additional information concerning the emergency situation, such as a photo or video of criminal suspects, etc.

In certain embodiments, the text messaging application 102 may be configured to autonomously include in or attach to a text message that is being sent to the predefined universal special number (e.g., to a designated emergency text message short code, such as US911) certain information, such as a user's pre-defined personal profile, which may include various information about the user like the user's emergency contacts, physician information, medical condition information, allergy information, etc. Device 301 may include a send button 313 or other suitable interface for triggering the sending of the text message to the designated number.

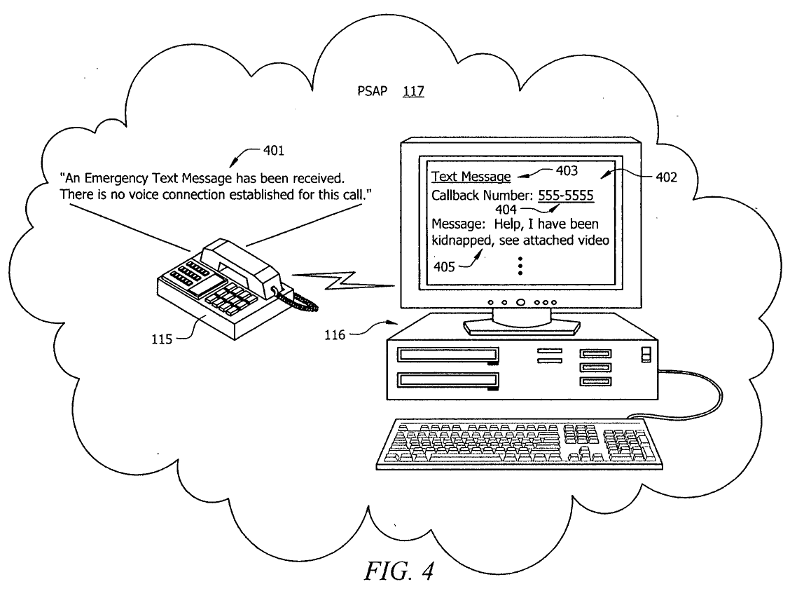

FIG. 4 shows an exemplary PSAP operator station that may be implemented within a PSAP 117 to which a text message may be routed from text message router 112 of FIG. 1. The operator station includes a voice telephone 115 and a display 116. As discussed above, in certain embodiments, the display 116 may be a display for displaying ANI and/or ALI information accompanying received emergency voice calls. As discussed with FIG. 1, in certain embodiments, text message router 112 sends, via data connection 114, a text message to display 116. An example of the output to display 116 (e.g., according to a reformatted text message sent by text message router 112 in certain embodiments) is shown as text output 402 in FIG. 4. Such text output 402 includes a heading 403 that identifies the information being displayed as originating from a text message. A callback number 404 may, in certain embodiments, also be presented, which may identify the callback number of the sending device from which the text message originated. Of course, depending on the situation, the PSAP operator may choose not to use the callback number for initiating a voice communication (e.g., if it may place the caller in danger). But, in some instances, the PSAP operator may have the option of using a text messaging device for sending text message communication to the sending device. The text output 402 further includes a field 405 for presenting the text message. Of course, additional information, such as accompanying attachments, etc. may, in certain embodiments, also be displayed, or such accompanying attachments may be relayed by the operator to another device (e.g., a personal computer, etc.) for display. A corresponding voice message 401 may be communicated (via voice connection 113) to PSAP 117 to be played on voice telephone 115.

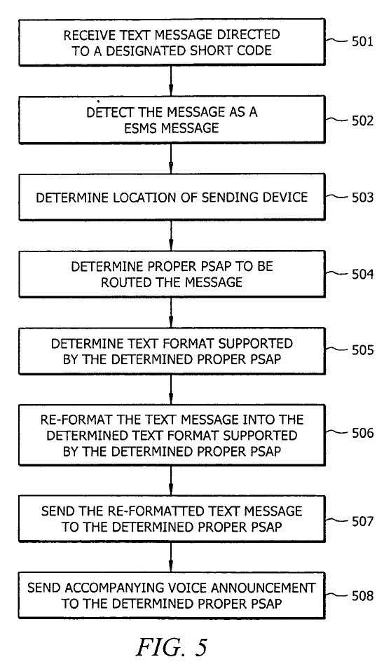

FIG. 5 shows an operational flow diagram of an intermediate router (e.g., text message router 112) according to one embodiment of the present invention. In block 501, a text message that is directed to a designated universal calling number (e.g., a designated short code, such as US911) is received. In block 502, the text message is identified as a special text message, such as an emergency text message (e.g., emergency SMS or “ESMS”). The text message may be so identified in certain embodiments by virtue of the particular universal calling number to which it was sent. For instance, a text message sent to short code US911 may be recognized as an emergency text message.

In block 503, the geographic location of the sending device is determined. As discussed above with location determining device 111 of FIG. 1, various techniques may be employed for determining such location. In block 504, a proper endpoint (e.g., proper PSAP) to be routed the text message is determined. As discussed above with FIGS. 1-2, in certain embodiments, such proper endpoint may be determined through a database lookup operation based, at least in part, on the determined geographic location of the sending device.

In block 505, a text format that is supported by the determined proper endpoint (e.g., proper PSAP) to which the text message is to be routed is determined. As discussed above with FIGS. 1-2, in certain embodiments, such supported format may be determined through a database lookup operation.

In block 506, the text message may be reformatted into the determined text format that is supported by the determined proper endpoint (e.g., proper PSAP) to which the text message is to be routed. For instance, as discussed above, the text message may be reformatted for proper display on an ALI display of a PSAP. That is, the text message may be formatted into a format that is compatible with ALI information that is received by the PSAP for voice emergency calls.

In block 507, the reformatted text message is sent to the determined proper endpoint (e.g., the proper PSAP). In block 508, an accompanying voice announcement may likewise be sent to the determined proper endpoint (e.g., the proper PSAP) to notify the operator of the text message.

Many of the elements described herein, when implemented via computer-executable instructions, are in essence the software code defining the operations thereof. For instance, the above-described text message router 112 may comprise software code for performing the operations described as being performed by the text message router 112. Also, a sending device may comprise software code implementing a text messaging application 102, as discussed above. The executable instructions or software code may be obtained, for example, from a readable medium (e.g., a hard drive media, optical media, EPROM, EEPROM, tape media, cartridge media, flash memory, ROM, memory stick, and/or the like). In certain embodiments, a CPU may execute the various logical instructions according to embodiments of the present invention. For example, a CPU may execute machine-level instructions according to the exemplary operational flow described above in conjunction with FIG. 5.

It shall be appreciated that the present invention is not limited to the architecture of the system on embodiments thereof may be implemented. For example, any suitable processor-based device may be utilized for implementing the above-described intermediate router (e.g., the text message portal 104, location determining device 111, and/or text message router 112), including without limitation personal computers, laptop computers, computer workstations, and multi-processor servers. Moreover, certain aspects of embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

While emergency (e.g., 9-1-1 or E9-1-1 type calls) are described in many of the exemplary embodiments provided herein, it should be recognized that the concepts described herein may be likewise employed for other special calling systems. For example, there are other abbreviated number calling systems in place in the United States and abroad for such purposes as handling municipal information and services calls (e.g., 3-1-1 calls) and for other special purposes. All of these special, or abbreviated number call systems that have geographic-based content may be implemented for supporting text messaging to an action-response facility geographically proximate to the locus of the caller in a manner similar to that described herein for emergency text messaging.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for routing a geographically-sensitive text message, the method comprising:
receiving a geographically-sensitive text message from a sending device, said text message sent from the sending device to a universally known calling number;
determining a present physical location of the sending device, said determining based upon a knowledge of physical coordinates of said sending device;
determining, based at least in part on the determined present physical location of the sending device, a proper service point to which the text message is to be routed; and
determining a text output format of a text output display of the determined proper service point;
reformatting the text message into the determined text output format; and
sending the reformatted text message to the identified proper service point for display on the text output display.

2. The method of claim 1 wherein the text message is an emergency text message.

3. The method of claim 2 wherein determining the proper service point to which the text message is to be routed comprises:
determining a proper Public Safety Answering Point (PSAP) to which the text message is to be routed.

4. The method of claim 3 wherein the text output display of the PSAP comprises a text output display for outputting textual information associated with voice calls received by the PSAP.

5. The method of claim 4 wherein the text output display of the PSAP comprises an Automatic Location Information (ALI) display of the PSAP.

6. The method of claim 1 wherein the universally known calling number comprises a universally known short code for emergency calls.

7. The method of claim 1 wherein the sending device is a mobile sending device.

8. The method of claim 1 wherein the sending device is a wireless communication device comprising an interface to a wireless communication network, where the sending device sends the text message via the interface.

9. The method of claim 1 wherein the text message comprises one of:
a Short Message Service (SMS) message, a Multimedia Messaging Service (MMS) message, and a text file.

10. The method of claim 1 further comprising:
receiving the reformatted text message at the identified proper service point; and
displaying on a text output display at the identified proper service point, the received reformatted text message.

11. A system for geographically-sensitive text message routing, said system comprising:
an interface for receiving a geographically-sensitive text message sent by a sending device to a predefined universal telephone number;
an interface for receiving geospatial coordinates of the sending device's location;
determining logic for determining a proper service point to which the received text message is to be routed based upon said geospatial coordinates of the sending device's location;
logic for determining a text output format of a text output display of the determined proper service point;
reformatting logic for reformatting the text message into the determined text output format; and
communication interface for sending the reformatted text message to the identified proper service point for display on the text output display.

12. The system of claim 11 wherein the text message is an emergency text message.

13. The system of claim 12 wherein the determining logic for determining the proper service point to which the received text message is to be routed comprises:
determining logic for determining a proper Public Safety Answering Point (PSAP) to which the text message is to be routed.

14. The system of claim 13 wherein the text output display of the PSAP comprises a text output display for outputting textual information associated with voice calls received by the PSAP.

15. The system of claim 14 wherein the text output display of the PSAP comprises an Automatic Location Information (ALI) display of the PSAP.

16. The system of claim 11 wherein the predefined universal telephone number comprises a predefined universal short code for emergency calls.

17. The system of claim 11 wherein the sending device is a mobile sending device.

18. The system of claim 11 wherein the sending device is a wireless communication device comprising an interface to a wireless communication network, where the sending device sends the text message via the interface.

19. The system of claim 11 wherein said logic for determining a text output format of the text output display of the determined proper service point comprises: logic for performing a database lookup to determine said text output format of the text output display of the determined proper service point.

20. A text message router for routing emergency text messages, said text message router comprising:
an interface for receiving an emergency text message that is sent from a sending device to a universally known emergency calling number;
an interface for receiving geographical location coordinates of the sending device;
communicative coupling with a database that is stored to a computer-readable medium, said database comprising information for coordinating the received geographical location coordinates of the sending device with a proper one of a plurality of different Public Safety Answering Points (PSAPs);
a matching circuit for matching the received emergency text message with the proper one of the plurality of different PSAPs based upon said database information; and
an interface for routing the emergency text message to the proper one of the plurality of different PSAPs.

21. The text message router of claim 20 further comprising:
communicative coupling with a formatting database that is stored to a computer-readable medium, said formatting database comprising information specifying a text output format of a text output display of a corresponding one of the plurality of different Public Safety Answering Points (PSAPs);
logic for determining, from the formatting database, a text output format of a text output display of the determined proper service point; and
reformatting logic for reformatting the text message into the determined text output format.

22. The text message router of claim 21 wherein said interface for routing the emergency text message to the proper one of the plurality of different PSAPs comprises:
an interface for sending the reformatted text message to the proper one of the plurality of different PSAPs for display on the PSAP's text output display.

23. The text message router of claim 20 wherein said matching circuit comprises:
a geospatial coordinate generator for determining a geospatial coordinate for the current physical location of the sending device; and
identifying logic for identifying said proper one of the plurality of different PSAPs to which the text message is to be routed based upon said determined geospatial coordinate.

24. The text message router of claim 23 wherein said geospatial coordinate generator determines the geospatial coordinate based at least in part on an automatic number identification (ANI) determined for the call.

25. A method for text message routing, said method comprising:
receiving an emergency text message from a calling party, said text message directed to a universally known calling number;
determining a present physical location of said calling party, said determining based upon a knowledge of physical coordinates of said calling party; and
completing said emergency text message to a service center pre-identified as serving said present physical location based upon said determined present physical location of said calling party.

26. The method of claim 25 further comprising:
determining, based at least in part on the determined present physical location of the sending device, said service center to which the text message is to be routed.

27. The method of claim 25 wherein said completing said emergency text message to said service center comprises:
determining a text output format of a text output display of the service center;
reformatting the emergency text message into the determined text output format; and
sending the reformatted text message to the service center for display on the text output display.

28. A system for emergency text message routing, said system comprising:
an interface for receiving an emergency text message sent by a caller to a predefined universal telephone number;
a geospatial coordinate generator for determining a geospatial coordinate for the location of the caller; and
identifying logic for identifying a proper Public Safety Answering Point (PSAP) to which the emergency text message is to be routed based upon said determined geospatial coordinate.

29. The system of claim 28 further comprising:
format determining logic for determining a text output format of a text output display of the identified proper PSAP; and
reformatting logic for reformatting the text message into the determined text output format.

30. The system of claim 29 further comprising:
communication interface for sending the reformatted text message to the identified proper PSAP for display on the text output display.
